(19) United States
(12) Patent Application Publication
(10) Pub. No.: US 2022/0253028 A1
(43) Pub. Date: Aug. 11, 2022

(54) INFORMATION PROCESSING DEVICE, INFORMATION PROCESSING SYSTEM, PROGRAM, AND SUPPLY VEHICLE

(71) Applicant: TOYOTA JIDOSHA KABUSHIKI KAISHA, Toyota-shi (JP)

(72) Inventors: Yui SUGIE, Nagoya-shi (JP); Hikaru GOTOH, Nagoya-shi (JP); Hiroki KIDO, Miyoshi-shi (JP); Shuichi SAWADA, Nagoya-shi (JP); Genshi KUNO, Kasugai-shi (JP); Katsuhiro OHARA, Nagoya-shi (JP)

(73) Assignee: TOYOTA JIDOSHA KABUSHIKI KAISHA, Toyota-shi (JP)

(21) Appl. No.: 17/554,295

(22) Filed: Dec. 17, 2021

(30) Foreign Application Priority Data
Feb. 5, 2021 (JP) 2021-017769

(51) Int. Cl. G05B 19/042

(52) U.S. Cl. CPC G05B 19/042; G06Q 50/06

(57) ABSTRACT

An information processing device includes a control unit configured to acquire first usage of a power source of a vehicle that supplies energy used in the vehicle in a predetermined period in which an occupant takes refuge by staying in the vehicle and to determine a supply of the power source which is able to be supplied to the vehicle based on the acquired first usage.

### CROSS-REFERENCE TO RELATED APPLICATION

This application claims priority to Japanese Patent Application No. 2021-017769 filed on Feb. 5, 2021, incorporated herein by reference in its entirety.

### BACKGROUND

### 1. Technical Field

The present disclosure relates to an information processing device, an information processing system, a program, and a supply vehicle.

### 2. Description of Related Art

When a disaster such as an earthquake occurs, a fuel pipe or a fuel feeder in a gas station that supplies petroleum fuel such as gasoline may be damaged and thus petroleum fuel in an underground storage may not be fed. A technique of supplying petroleum fuel such as gasoline to a vehicle even in such a disaster is known. For example, Japanese Unexamined Patent Application Publication No. 2013-056674 (JP 2013-056674 A) discloses a portable fuel feeder that can safely and rapidly feed petroleum fuel to a vehicle or the like even when a fuel feeder cannot feed fuel at the time of occurrence of a disaster such as an earthquake and that can be easily handled.

### SUMMARY

When supplies of a power source for a vehicle including petroleum fuel are equalized among vehicles, there may be a vehicle in which actual usage and a supply of a power source do not match, for example, when people stay in a vehicle for refuge. In the related art, there is room for improvement in view of resolution of such a mismatch.

The present disclosure provides a technique for improving matchability between actual usage and a supply of a power source of a vehicle when people am staying in the vehicle for refuge.

According to an embodiment of the present disclosure, there is provided an information processing device including a control unit configured to acquire first usage of a power source of a vehicle that supplies energy used in the vehicle in a predetermined period in which an occupant takes refuge by staying in the vehicle and to determine a supply of the power source which is able to be supplied to the vehicle based on the acquired first usage.

According to another embodiment of the present disclosure, there is provided a program causing an information processing device to perform an operation including: acquiring first usage of a power source of a vehicle that supplies energy used in the vehicle in a predetermined period in which an occupant takes refuge by staying in the vehicle; and determining a supply of the power source which is able to be supplied to the vehicle based on the acquired first usage.

According to another embodiment of the present disclosure, there is provided a supply vehicle including a control unit configured to acquire first usage of a power source of a vehicle that supplies energy used in the vehicle in a predetermined period in which an occupant takes refuge by staying in the vehicle and to determine a supply of the power source which is able to be supplied to the vehicle based on the acquired first usage.

With the information processing device, the information processing system, the program, and the supply vehicle according to the embodiments of the present disclosure, it is possible to improve matchability between actual usage and a supply of a power source of a vehicle when people are staying in the vehicle for refuge.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing system including an information processing device according to an embodiment of the present disclosure:

FIG. 2 is a functional block diagram schematically illustrating configurations of the information processing device, a vehicle, and a supply vehicle illustrated in FIG. 1;

FIG. 3 is a sequence diagram illustrating an example of an information processing method which is performed by the information processing system illustrated in FIG. 1;

FIG. 4 is a flowchart illustrating an example of an information processing method which is performed by the information processing device illustrated in FIG. 1; and

FIG. 5 is a diagram exemplarily illustrating a process of determining a supply of a power source of a vehicle and a process of correcting the supply of a power source which are performed by the information processing device illustrated in FIG. 1.

### DETAILED DESCRIPTION OF EMBODIMENTS

Hereinafter, an embodiment of the present disclosure will be described with reference to the accompanying drawings.

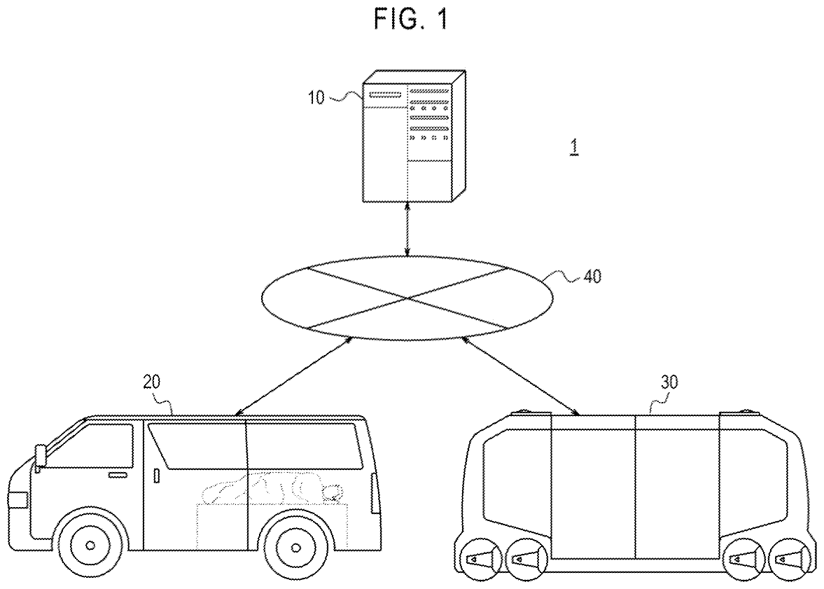

FIG. 1 is a diagram illustrating a configuration of an information processing system 1 including an information processing device 10 according to an embodiment of the present disclosure. An outline of the information processing system 1 including the information processing device 10 according to the embodiment of the present disclosure will be described below with reference to FIG. 1. The information processing system 1 includes a vehicle 20 and a supply vehicle 30 in addition to the information processing device 10.

For the purpose of convenience of illustration, a single information processing device 10, a single vehicle 20, and a single supply vehicle 30 are illustrated in FIG. 1, but the number of information processing devices 10, the number of vehicles 20, and the number of supply vehicles 30 in the information processing system 1 may be two or more. The information processing device 10, the vehicle 20, and the supply vehicle 30 are communicatively connected to, for example, a network 40 including a mobile communication network, the Internet, and the like.

The information processing device 10 is one server device or a plurality of server devices that can communicate with each other. The information processing device 10 is not limited thereto and may be an arbitrary general-purpose electronic device such as a personal computer (PC) or a smartphone or may be another dedicated electronic device for the information processing system 1.

The vehicle 20 includes, for example, an arbitrary vehicle that is used for an occupant to take refuge in when a disaster such as an earthquake occurs and in which an occupant is able to take lodging. The vehicle 20 is, for example, a vehicle that is driven by a driver. The vehicle 20 is not limited to such a vehicle and may be, for example, a vehicle that performs automated driving. Automated driving includes, for example, levels 1 to 5 which are defined by the Society of Automotive Engineers (SAE), but is not limited thereto. Automated driving may be arbitrarily defined.

For example, an occupant of the vehicle 20 takes refuge while staying in the vehicle 20 when a disaster such as an earthquake occurs. At this time, the occupant of the vehicle 20 may use an air conditioner and a car navigation system that are provided in the vehicle 20. The occupant of the vehicle 20 may charge an information processing terminal such as a smartphone or use home electric appliances including a television, a radio receiver, and a water heater using a power supply unit which is provided in the vehicle 20 such as a cigar socket and a Universal Serial Bus (USB) connector.

Since an occupant uses various devices and systems in the vehicle 20 as described above, energy, for example, electric energy, is consumed in the vehicle 20. Such energy consumed in the vehicle 20 is supplied from a power source of the vehicle 20. With consumption of energy, the power source of the vehicle 20 is used and a residual amount thereof decreases. In this specification, the “power source” includes, for example, at least one of petroleum fuel such as gasoline, electric power with which a battery is charged, and hydrogen fuel for driving a fuel battery. The power source is not limited thereto and may include an arbitrary power source that can supply energy used in the vehicle 20.

The supply vehicle 30 includes, for example, an arbitrary vehicle that can supply a power source of a vehicle 20 to a vehicle 20 in which an occupant takes refuge. The supply vehicle 30 is, for example, a vehicle that performs automated driving. Automated driving includes, for example, levels 1 to 5 which are defined by the SAE, but is not limited thereto. The automated driving may be arbitrarily defined. The supply vehicle 30 is not limited to a vehicle that performs automated driving and may be an arbitrary vehicle that is driven by a driver.

For example, when the power source of the vehicle 20 is petroleum fuel such as gasoline, the supply vehicle 30 may include an arbitrary fuel supply vehicle that can store and transport such petroleum fuel. For example, when the power source of the vehicle 20 is electric power with which a battery is charged, the supply vehicle 30 may include an arbitrary power supply vehicle that can have move with a battery charged with a large amount of electric power mounted therein. For example, when the power source of the vehicle 20 is hydrogen fuel for driving a fuel battery, the supply vehicle 30 may include an arbitrary vehicle that can store and transport such hydrogen fuel.

According to this embodiment, the information processing device 10 acquires first usage in a predetermined period in which an occupant takes refuge by staying in the vehicle 20 as first usage of the power source of the vehicle 20 that supplies energy used in the vehicle 20. In this specification, the “predetermined period” includes, for example, an arbitrary period in which the first usage of the power source of the vehicle 20 during refuge of an occupant in the vehicle 20 can be accurately acquired as data from the vehicle 20 by the information processing device 10. For example, the predetermined period may be one day. The information processing device 10 determines a supply of the power which can be supplied to the vehicle 20 based on the acquired first usage.

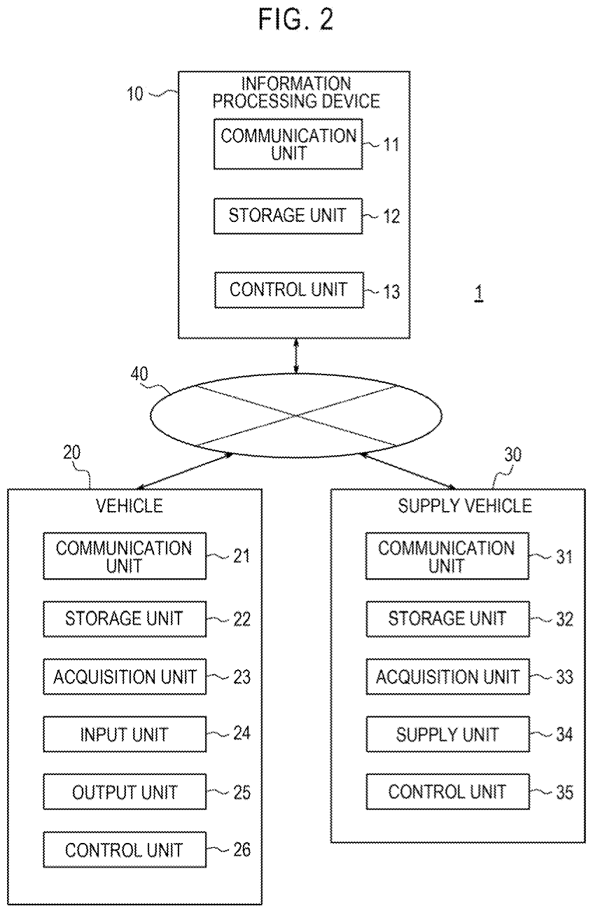

The configurations of the information processing device 10, the vehicle 20, and the supply vehicle 30 included in the information processing system 1 will be described below with reference to FIG. 2. FIG. 2 is a functional block diagram schematically illustrating the configurations of the information processing device 10, the vehicle 20, and the supply vehicle 30 illustrated in FIG. 1.

As illustrated in FIG. 2, the information processing device 10 includes a communication unit 11, a storage unit 12, and a control unit 13.

The communication unit 11 includes a communication module that is connected to the network 40. For example, the communication unit 11 may include a communication module corresponding to a mobile communication standard such as 4th generation (4G) or 5th generation (5G) or an Internet standard. In this embodiment, the information processing device 10 is connected to the network 40 via the communication unit 11. The communication unit 11 transmits and receives various types of information via the network 40.

The storage unit 12 is, for example, a semiconductor memory, a magnetic memory, or an optical memory, but is not limited thereto. The storage unit 12 may serve as, for example, a main storage device, an auxiliary storage device, or a cache storage device. The storage unit 12 stores arbitrary information which is used to operate the information processing device 10. For example, the storage unit 12 may store system programs, application programs, various types of information which are received or transmitted by the communication unit 11, and the like. Information stored in the storage unit 12 may also be updated, for example, with information which is received from the network 40 via the communication unit 11.

The control unit 13 includes one or more processors. A “processor” in this embodiment is a general-purpose processor or a dedicated processor for a specific process, but is not limited thereto. The control unit 13 is communicatively connected to the constituents of the information processing device 10 and controls operations of the information processing device 10 as a whole.

The configuration of the vehicle 20 includes in the information processing system 1 will be described below. As illustrated in FIG. 2, the vehicle 20 includes a communication unit 21, a storage unit 22, an acquisition unit 23, an input unit 24, an output unit 25, and a control unit 26. The communication unit 21, the storage unit 22, the acquisition unit 23, the input unit 24, the output unit 25, and the control unit 26 are communicatively connected to each other, for example, via an onboard network such as a controller area network (CAN) or a dedicated line.

The communication unit 21 includes a communication module that is connected to the network 40. For example, the communication unit 21 may include a communication module corresponding to a mobile communication standard such as 4G or 5G. In this embodiment, the vehicle 20 is connected to the network 40 via the communication unit 21. The communication unit 21 transmits and receives various types of information via the network 40.

The storage unit 22 is, for example, a semiconductor memory, a magnetic memory, or an optical memory, but is not limited thereto. The storage unit 22 may serve as, for example, a main storage device, an auxiliary storage device, or a cache storage device. The storage unit 22 stores arbitrary information which is used to operate the vehicle 20. For example, the storage unit 22 may store system programs, application programs, various types of information which are received or transmitted by the communication unit 21, and the like. Information stored in the storage unit 22 may also be updated, for example, with information which is received from the network 40 via the communication unit 21.

The acquisition unit 23 includes an arbitrary sensor module that can acquire usage of the power source of the vehicle 20 that supplies energy used in the vehicle 20. For example, when the power source of the vehicle 20 is petroleum fuel such as gasoline, the acquisition unit 23 may include a sensor module that can measure an amount of injected fuel of the vehicle 20. For example, when the power source of the vehicle 20 is electric power with which a battery is charged, the acquisition unit 23 may include an electric power sensor module that can measure power consumption of the vehicle 20. For example, when the power source of the vehicle 20 is hydrogen fuel for driving a fuel cell, the acquisition unit 23 may include a sensor module that can measure an amount of consumed fuel of the vehicle 20.

The acquisition unit 23 includes one or more receivers corresponding to an arbitrary satellite positioning system. For example, the acquisition unit 23 may include a Global Positioning System (GPS) receiver. The acquisition unit 23 acquires a measured value of the position of the vehicle 20 as position information. The position information includes, for example, an address, latitude, longitude, and altitude. The acquisition unit 23 may continuously acquire position information of the vehicle 20 or may periodically or non-periodically acquire the position information.

For example, the input unit 24 includes one or more input interfaces that receive an input operation from an occupant in the vehicle 20 and acquire input information based on the occupant's input operation. For example, the input unit 24 includes an input interface constituting a car navigation system. For example, the input unit 24 includes a touch screen that is integrally provided with a liquid crystal monitor constituting the car navigation system. For example, the input unit 24 receives an occupant's input operation based on the occupant's touch operation.

The input unit 24 is not limited thereto and may include an arbitrary input interface that can detect an occupant's input operation and acquire input information based on the occupant's input operation. For example, the input unit 24 may include physical keys, capacitance keys, and a microphone that receives a voice input.

For example, the output unit 25 includes one or more output interfaces that output information to an occupant in the vehicle 20. For example, the output unit 25 includes an output interface constituting the car navigation system. For example, the output unit 25 includes the liquid crystal monitor constituting the car navigation system. For example, the output unit 25 outputs information as at least one of an image and voice.

The output unit 25 is not limited thereto and may include an arbitrary output interface affecting at least one of a sense of sight and a sense of hearing of an occupant in the vehicle 20. For example, the output unit 25 may include another arbitrary voice output interface that mainly affects a sense of hearing of an occupant in the vehicle 20, other than the car navigation system. For example, the output unit 25 may include another arbitrary image output interface that mainly affects a sense of sight of an occupant in the vehicle 20, other than the car navigation system.

The control unit 26 includes one or more processors. A “processor” in this embodiment is a general-purpose processor or a dedicated processor for a specific process, but is not limited thereto. For example, the control unit 26 may include an electronic control unit (ECU). The control unit 26 is communicatively connected to the constituents of the vehicle 20 and controls operations of the vehicle 20 as a whole.

The configuration of the supply vehicle 30 includes in the information processing system 1 will be described below. As illustrated in FIG. 2, the supply vehicle 30 includes a communication unit 31, a storage unit 32, an acquisition unit 33, a supply unit 34, and a control unit 35. The communication unit 31, the storage unit 32, the acquisition unit 33, the supply unit 34, and the control unit 35 are communicatively connected to each other, for example, via an onboard network such as CAN or a dedicated line.

The communication unit 31 includes a communication module that is connected to the network 40. For example, the communication unit 31 may include a communication module corresponding to a mobile communication standard such as 4G or 5G. In this embodiment, the supply vehicle 30 is connected to the network 40 via the communication unit 31. The communication unit 31 transmits and receives various types of information via the network 40.

The storage unit 32 is, for example, a semiconductor memory, a magnetic memory, or an optical memory, but is not limited thereto. The storage unit 32 may serve as, for example, a main storage device, an auxiliary storage device, or a cache storage device. The storage unit 32 stores arbitrary information which is used to operate the supply vehicle 30. For example, the storage unit 32 may store system programs, application programs, various types of information which are received or transmitted by the communication unit 31, and the like. Information stored in the storage unit 32 may also be updated, for example, with information which is received from the network 40 via the communication unit 31.

The acquisition unit 33 includes one or more receivers corresponding to an arbitrary satellite positioning system. For example, the acquisition unit 33 may include a GPS receiver. The acquisition unit 33 acquires a measured value of a position of the supply vehicle 30 as position information. The position information includes, for example, an address, latitude, longitude, and altitude. The acquisition unit 33 may continuously acquire the position information of the supply vehicle 30 or may periodically or non-periodically acquire the position information.

The supply unit 34 includes an arbitrary supply mechanism that can supply a power source of a vehicle 20 to the vehicle 20. For example, when the power source of the vehicle 20 is petroleum fuel such as gasoline, the supply unit 34 may include a fuel supply mechanism that can supply petroleum fuel stored in the supply vehicle 30 to the vehicle 20. For example, when the power source of the vehicle 20 is electric power with which a battery is charged, the supply unit 34 may include an electric power supply mechanism that can supply electric power charged in the battery mounted in the supply vehicle 30 to the vehicle 20. For example, when the power source of the vehicle 20 is hydrogen fuel for driving a fuel cell, the supply unit 34 may include a supply mechanism that can supply hydrogen fuel stored in the supply vehicle 30 to the vehicle 20.

The control unit 35 includes one or more processors. A “processor” in this embodiment is a general-purpose processor or a dedicated processor for a specific process, but is not limited thereto. For example, the control unit 35 may include an ECU. The control unit 35 is communicatively connected to the constituents of the supply vehicle 30 and controls operations of the supply vehicle 30 as a whole.

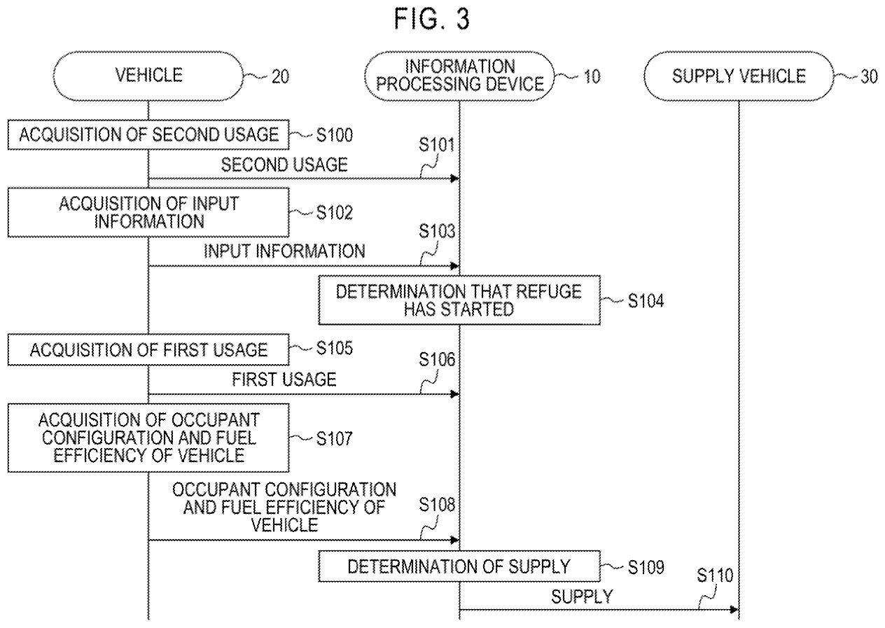

FIG. 3 is a sequence diagram illustrating an example of an information processing method which is performed by the information processing system 1 illustrated in FIG. 1. An example of an information processing method which is performed by the information processing system 1 illustrated in FIG. 1 will be described below with reference to FIG. 3. The sequence diagram illustrated in FIG. 3 illustrates a basic flow of processes of the information processing method which is performed by the information processing system 1.

In Step S100, the control unit 26 of the vehicle 20 acquires second usage of the power source of the vehicle 20 in a normal period before refuge of an occupant in the vehicle 20 has been started via the acquisition unit 23. In this specification, the “normal period” includes, for example, an arbitrary period in which the second usage of the power source of the vehicle 20 in a normal life of the occupant using the vehicle 20 can be accurately acquired as data from the vehicle 20 by the information processing device 10. For example, the normal period may be one day.

In Step S101, the control unit 26 of the vehicle 20 transmits information on the second usage acquired in Step S100 to the information processing device 10 via the communication unit 21 and the network 40. Accordingly, the control unit 13 of the information processing device 10 acquires the second usage of the power source of the vehicle 20.

In Step S102, the control unit 26 of the vehicle 20 acquires input information indicating that refuge of an occupant with lodging in the vehicle 20 has been started from the occupant via the input unit 24.

In Step S103, the control unit 26 of the vehicle 20 transmits the input information acquired in Step S102 to the information processing device 10 via the communication unit 21 and the network 40. Accordingly, the control unit 13 of the information processing device 10 acquires the input information indicating that the refuge of the occupant with lodging in the vehicle 20 has been started.

In Step S104, the control unit 13 of the information processing device 10 determines that the refuge of the occupant has been started based on the input information acquired from the occupant of the vehicle 20 in Step S102.

In Step S105, the control unit 26 of the vehicle 20 acquires first usage of the power source of the vehicle 20 that supplies energy used in the vehicle 20 in a predetermined period in which the refuge of the occupant with lodging in the vehicle 20 is made via the acquisition unit 23.

In Step S106, the control unit 26 of the vehicle 20 transmits information of the first usage acquired in Step S105 to the information processing device 10 via the communication unit 21 and the network 40. Accordingly, the control unit 13 of the information processing device 10 acquires the first usage of the power source of the vehicle 20.

In Step S107, the control unit 26 of the vehicle 20 acquires an occupant configuration in the vehicle 20 and a fuel efficiency of the vehicle 20. For example, the control unit 26 may acquire the occupant configuration based on an image captured by an arbitrary imaging module that can image the inside of the vehicle 20. Such an imaging module may be included in the acquisition unit 23. In this specification, the “occupant configuration” includes, for example, the number of occupants and age, sex, nationality, and races of the occupants. For example, the control unit 26 may acquire the fuel efficiency of the vehicle 20 as an average value based on past travel information of the vehicle 20 stored in the storage unit 22 or may acquire the fuel efficiency of the vehicle 20 as a predetermined range from a maximum value to a maximum value.

In Step S108, the control unit 26 of the vehicle 20 transmits information of the occupant configuration and the fuel efficiency of the vehicle 20 acquired in Step S107 to the information processing device 10 via the communication unit 21 and the network 40. Accordingly, the control unit 13 of the information processing device 10 acquires the occupant configuration and the fuel efficiency of the vehicle 20.

In Step S109, the control unit 13 of the information processing device 10 determines a supply of the power source that can be supplied to the vehicle 20 based on the first usage of the power source of the vehicle 20 acquired in Step S106. At this time, the control unit 13 may correct the determined supply based on at least one of the second usage of the power source of the vehicle 20 acquired in Step S101 and the occupant configuration in the vehicle 20 and the fuel efficiency of the vehicle 20 acquired in Step S108.

In Step S110, the control unit 13 of the information processing device 10 transmits information of the supply of the power source that can be supplied to the vehicle 20, which has been determined or corrected in Step S109, to the supply vehicle 30 via the communication unit 11 and the network 40. The supply vehicle 30 supplies an amount of power source corresponding to the supply to the vehicle 20 via the supply unit 34 based on the received information of the supply.

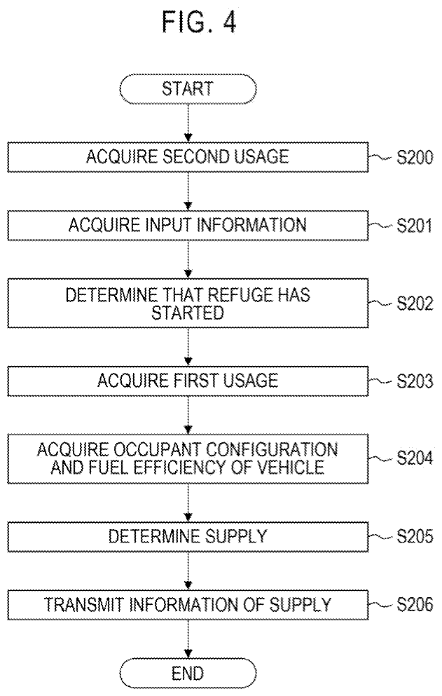

FIG. 4 is a flowchart illustrating an example of an information processing method which is performed by the information processing device 10 illustrated in FIG. 1. An example of the information processing method which is performed by the information processing device 10 illustrated in FIG. 1 will be described below with reference to FIG. 4. The flowchart illustrated in FIG. 4 illustrates a basic flow of processes of the information processing method which is performed by the information processing device 10.

In Step S200, the control unit 13 of the information processing device 10 acquires second usage of the power source of the vehicle 20 in a normal period before refuge of an occupant in the vehicle 20 has been started.

In Step S201, the control unit 13 acquires input information indicating that refuge of an occupant with lodging in the vehicle 20 has been started. Such input information is first acquired by the vehicle 20 based on the occupant's input operation using the input unit 24.

In Step S202, the control unit 13 determines that the refuge of the occupant in the vehicle 20 has been started based on the input information acquired in Step S201.

In Step S203, the control unit 13 acquires first usage in a predetermined period in which the refuge of the occupant with lodging in the vehicle 20 is made as the first usage of the power source of the vehicle 20 that supplies energy used in the vehicle 20.

In Step S204, the control unit 13 acquires an occupant configuration in the vehicle 20 and a fuel efficiency of the vehicle 20.

In Step S205, the control unit 13 determines a supply of the power source that can be supplied to the vehicle 20 based on the first usage acquired in Step S203. At this time, the control unit 13 may correct the determined supply based on at least one of the second usage of the power source of the vehicle 20 acquired in Step S200 and the occupant configuration in the vehicle 20 and the fuel efficiency of the vehicle 20 acquired in Step S204.

In Step S206, the control unit 13 transmits information of the supply of the power source that can be supplied to the vehicle 20, which has been determined or corrected in Step S205, to the supply vehicle 30 via the communication unit 11 and the network 40.

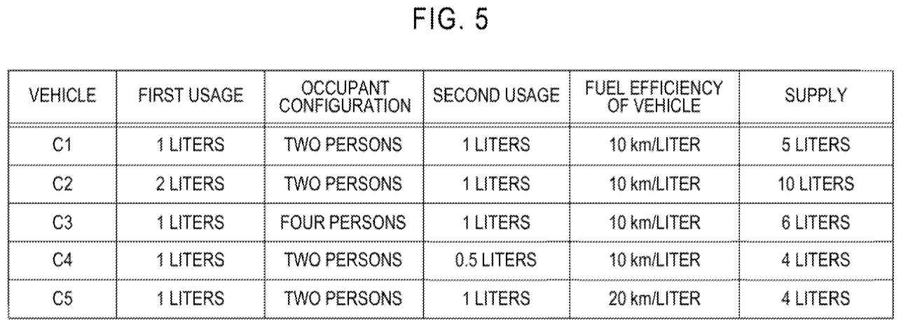

FIG. 5 is a diagram exemplarily illustrating a process of determining a supply of a power source of a vehicle 20 and a process of correcting the supply of the power source which are performed by the information processing device 10 illustrated in FIG. 1. An example of the process of determining a supply of a power source of a vehicle 20 and the process of correcting the supply of the power source which are performed by the information processing device 10 illustrated in FIG. 1 will be described below with reference to FIG. 5.

For example, the control unit 13 of the information processing device 10 may predict for what days from a scheduled supply date and time of the power source to the vehicle 20 the refuge of the occupant with lodging in the vehicle 20 is to be continued based on a scale of a disaster such as an earthquake. The control unit 13 may determine the supply of the power source that can be supplied to the vehicle 20 by multiplying the remaining days of the refuge acquired based on such a prediction process by first usage per day calculated based on the acquired first usage of the power source of the vehicle 20. Alternatively, the control unit 13 may calculate what days there are between a scheduled supply date and time of the power source to the vehicle 20 and a next scheduled supply data and time. The control unit 13 may determine the supply of the power source that can be supplied to the vehicle 20 by multiplying the remaining days to the next supply acquired based on such a calculation process by first usage per day calculated based on the acquired first usage of the power source of the vehicle 20. In FIG. 5, for example, it is assumed that the predetermined period is one day and the power source is petroleum fuel such as gasoline.

For example, the control unit 13 acquires information indicating that the first usage per day is 1 liter for a vehicle C1. For example, the control unit 13 predicts that refuge of an occupant with lodging in the vehicle C1 is continued in five days from a scheduled supply date and time of the power source to the vehicle C1 based on a scale of a disaster such as an earthquake. At this time, the control unit 13 determines a supply of 5 liters by multiplying the remaining days of the refuge of 5 days by the first usage per day of 1 liter.

For example, the control unit 13 acquires information indicating that the first usage per day is 2 liters for a vehicle C2. For example, the control unit 13 predicts that refuge of an occupant with lodging in the vehicle C2 is continued in five days from a scheduled supply date and time of the power source to the vehicle C2 based on a scale of a disaster such as an earthquake. At this time, the control unit 13 determines a supply of 10 liters by multiplying the remaining days of the refuge of 5 days by the first usage per day of 2 liters.

For example, the control unit 13 may correct the supply of the power source in consideration of the occupant configuration in the vehicle 20 in the process of determining the supply. For example, the control unit 13 may correct the supply by additionally multiplying the supply determined through multiplication of the first usage per day and the remaining days of the refuge by a predetermined ratio.

For example, the control unit 13 acquires information indicating that the first usage per day is 1 liter for a vehicle C3. For example, the control unit 13 predicts that refuge of an occupant with lodging in the vehicle C3 is continued in five days from a scheduled supply date and time of the power source to the vehicle C3 based on a scale of a disaster such as an earthquake. At this time, the control unit 13 determines a supply of 5 liters by multiplying the remaining days of the refuge of 5 days by the first usage per day of 1 liter.

The control unit 13 acquires information indicating that the number of occupants in the vehicle C3 is four. For example, since the number of occupants in the vehicle C3 doubles the number of occupants in the vehicle C1 with two occupants as a reference, the control unit 13 may multiply the determined supply of 5 liters by a ratio of 1.2 indicating an increase of 20%. That is, the control unit 13 may correct the supply of 5 liters to 6 liters.

For example, the control unit 13 may correct the supply of the power source in consideration of the second usage of the power source of the vehicle 20 in a normal period in the process of determining the supply. For example, the control unit 13 may correct the supply by additionally multiplying the supply determined through multiplication of the first usage per day and the remaining days of the refuge by a predetermined ratio.

For example, the control unit 13 acquires information indicating that the first usage per day is 1 liter for a vehicle C4. For example, the control unit 13 predicts that refuge of an occupant with lodging in the vehicle C4 is continued in five days from a scheduled supply date and time of the power source to the vehicle C4 based on a scale of a disaster such as an earthquake. At this time, the control unit 13 determines a supply of 5 liters by multiplying the remaining days of the refuge of 5 days by the first usage per day of 1 liter.

The control unit 13 acquires information indicating that the second usage of the vehicle C4 is 0.5 liters. For example, since the second usage of the vehicle C4 decreases to half the second usage of the vehicle C1 with 1 liter as a reference, the control unit 13 may multiply the determined supply of 5 liters by a ratio of 0.8 indicating a decrease of 20%. That is, the control unit 13 may correct the supply of 5 liters to 4 liters.

For example, the control unit 13 may correct the supply of the power source in consideration of the fuel efficiency of the vehicle 20 in the process of determining the supply. For example, the control unit 13 may correct the supply by additionally multiplying the supply determined through multiplication of the first usage per day and the remaining days of the refuge by a predetermined ratio.

For example, the control unit 13 acquires information indicating that the first usage per day is 1 liter for a vehicle C5. For example, the control unit 13 predicts that refuge of an occupant with lodging in the vehicle C5 is continued in five days from a scheduled supply date and time of the power source to the vehicle C5 based on a scale of a disaster such as an earthquake. At this time, the control unit 13 determines a supply of 5 liters by multiplying the remaining days of the refuge of 5 days by the first usage per day of 1 liter.

The control unit 13 acquires information indicating that the fuel efficiency of the vehicle C5 is 20 km/liter. For example, since the fuel efficiency of the vehicle C5 doubles the fuel efficiency of the vehicle C1 with 10 km/liter as a reference, the control unit 13 may multiply the determined supply of 5 liters by a ratio of 0.8 indicating a decrease of 20%. That is, the control unit 13 may correct the supply of 5 liters to 4 liters.

The aforementioned correction processes and ratios are merely examples. The information processing device 10 may correct the determined supply based on an arbitrary correction process. The information processing device 10 may correct the determined supply based on an arbitrary ratio.

According to the aforementioned embodiment, it is possible to improve matchability between actual usage of a power source of a vehicle 20 due to staying in the vehicle for refuge and a supply of the power source. For example, since the information processing device 10 determines a supply based on the first usage of the power source of the vehicle 20 in the predetermined period, it is possible to accurately determine the supply to correspond to actual usage of the power source in which the occupant configuration of the vehicle 20, the fuel efficiency of the vehicle 20, and the like are reflected. Accordingly, it is possible to supply the power source to match the usage of the power source in the vehicle 20 and to curb problems such as energy shortage in refuge of an occupant in the vehicle 20. In comparison with the related art in which the supply of the power source of a vehicle is set to be constant for vehicles, it is possible to achieve fairness for every vehicle 20.

Since the information processing device 10 determines that refuge of an occupant has been started based on input information acquired from the occupant by a vehicle 20, it is possible to easily perform a process of determining start of refuge through self-declaration of the occupant of the vehicle 20.

Since the information processing device 10 corrects the determined supply based on the occupant configuration in the vehicle 20, it is possible to directly match the supply of the power source of the vehicle 20 with the occupant configuration. For example, even when the first usage of the power source in a predetermined period is the same for every vehicle 20, the usage of the power source ater the power source has been supplied to the vehicle 20 may change according to the occupant configuration. For example, in a vehicle 20 in which the number of occupants is larger, there is a likelihood that the usage of the power source will increase from the first usage in the future. The information processing device 10 can optimize the supply determined based on the first usage according to the occupant configuration in consideration of such a likelihood.

Accordingly, the information processing device 10 can accurately determine a supply of a power source in which the occupant configuration in the vehicle 20 is appropriately reflected. Accordingly, it is possible to supply the power source to match the occupant configuration in the vehicle 20 and to curb problems such as energy shortage in refuge of an occupant in the vehicle 20. In comparison with the related art in which the supply of the power source of a vehicle is set to be constant for vehicles, it is possible to achieve fairness for every vehicle 20.

Since the information processing device 10 corrects the determined supply based on the second usage of the power source in the normal period, it is possible to match the supply of the power source of the vehicle 20 with the usage of the power source in the vehicle 20 in the normal period. For example, even when the first usage of the power source in a predetermined period is the same for every vehicle 20, the usage of the power source after the power source has been supplied to the vehicle 20 may change according to the usage of the power source in the vehicles 20 in the normal period. For example, in a vehicle 20 in which the second usage is smaller, there is a likelihood that the usage of the power source will decrease from the first usage in the future. The information processing device 10 can optimize the supply determined based on the first usage according to the second usage in consideration of such a likelihood.

Accordingly, the information processing device 10 can accurately determine a supply of a power source in which the second usage of the power source in the vehicle 20 is appropriately reflected. Accordingly, it is possible to supply the power source to match the second usage of the power source in the vehicle 20 and to curb problems such as energy shortage in refuge of an occupant in the vehicle 20. In comparison with the related art in which the supply of the power source of a vehicle is set to be constant for vehicles, it is possible to achieve fairness for every vehicle 20.

Since the information processing device 10 corrects the determined supply based on the fuel efficiency of the vehicle 20, it is possible to directly match the supply of the power source in the vehicle 20 with the fuel efficiency of the vehicle 20. For example, even when the first usage of the power source in a predetermined period is the same for every vehicle 20, the usage of the power source after the power source has been supplied to the vehicle 20 may change according to the fuel efficiencies of the vehicles 20. For example, in a vehicle 20 with a better fuel efficiency, there is a likelihood that the usage of the power source will decrease from the first usage in the future. The information processing device 10 can optimize the supply determined based on the first usage according to the fuel efficiency of the vehicle 20 in consideration of such a likelihood.

Accordingly, the information processing device 10 can accurately determine a supply of a power source in which the fuel efficiency of the vehicle 20 is appropriately reflected. Accordingly, it is possible to supply the power source to match the fuel efficiency of the vehicle 20 and to curb problems such as energy shortage in refuge of an occupant in the vehicle 20. In comparison with the related art in which the supply of the power source of a vehicle is set to be constant for vehicles, it is possible to achieve fairness for every vehicle 20.

Since the power source includes at least one of petroleum fuel, electric power, and hydrogen fuel, the information processing device 10 can determine a supply of a power source to correspond to various types of vehicles 20 that are driven based on various types of power sources.

While the present disclosure has been described above with reference to the drawings and the embodiments, it will be noted that various modifications and corrections can be made by those skilled in the art. Accordingly, it should be noted that these modifications and corrections belong to the scope of the present disclosure. For example, functions included in the elements or the steps can be rearranged unless logical conflictions arise, and a plurality of elements or steps may be combined into a single element or step or a single element or step may be divided into two or more.

For example, at least some operations which are performed by the information processing device 10 in the aforementioned embodiment may be performed by the vehicle 20 or the supply vehicle 30. For example, the supply vehicle 30 instead of the information processing device 10 may perform the aforementioned operations associated with the information processing device 10. At least some operations which are performed by the vehicle 20 or the supply vehicle 30 may be performed by the information processing device 10.

For example, a configuration in which a general-purpose electronic device such as a smartphone or a computer is made to serve as the information processing device 10 according to the aforementioned embodiment may also be employed. Specifically, a program in which process details for realizing the functions of the information processing device 10 or the like according to the embodiment are described is stored in a memory of an electronic device and the program is read and executed by a processor of the electronic device. Accordingly, the disclosure according to the embodiment can also be realized as a program which can be executed by a processor.

Alternatively, the disclosure according to the embodiment can also be realized as a non-transitory computer-readable medium storing a program which can be executed by one or more processors in order for the information processing device 10 or the like to perform the functions. It should be understood that the program and the information processing device 10 are included in the scope of the present disclosure.

For example, the information processing device 10 described above in the embodiment may be mounted in the supply vehicle 30. In this case, the information processing device 10 may perform direct information communication with the supply vehicle 30 without using the network 40.

In the aforementioned embodiment, the information processing device 10 determines that refuge of an occupant has been started based on input information acquired from the occupant by the vehicle 20, but the disclosure is not limited thereto. The control unit 13 of the information processing device 10 may determine that refuge of an occupant has been started based on position information and a parking time of the vehicle 20 and a riding time of the occupant in the vehicle 20 instead of or in addition to such a determination process.

In this case, the control unit 13 may receive the position information of the vehicle 20, which is acquired by the control unit 26 of the vehicle 20 using the acquisition unit 23, from the vehicle 20 via the network 40 and the communication unit 11. The control unit 13 may indirectly calculate the parking time of the vehicle 20 based on the acquired position information of the vehicle 20 or may directly calculate the parking time of the vehicle 20 by acquiring information indicating that a shift lever of the vehicle 20 is located at a parking range from the vehicle 20. The control unit 13 may receive the riding time of the occupant in the vehicle 20, which is acquired by the control unit 26 of the vehicle 20 using a sear sensor provided in a seat of the vehicle 20, from the vehicle 20 via the network 40 and the communication unit 11. Without being limited thereto, the control unit 13 may receive the riding time of the occupant in the vehicle 20, which is acquired by the control unit 26 of the vehicle 20 from an image captured by an arbitrary imaging module that can image the inside of the vehicle 20, from the vehicle 20 via the network 40 and the communication unit 11. The seat sensor and the imaging module may be included in the acquisition unit 23 of the vehicle 20.

As described above, the information processing device 10 can accurately perform the process of determining start of refuge based on actual operations of the vehicle 20 and actual actions of an occupant. The information processing device 10 can more accurately perform the process of determining start of refuge based on all such information by comparing the input information acquired from the occupant by the vehicle 20 with the position information and the parking time of the vehicle 20 and the riding time of the occupant in the vehicle 20. That is, the information processing device 10 can more accurately perform the process of determining start of refuge while determining whether the self-declaration of the occupant of the vehicle 20 matches the actual operation of the vehicle 20 and the actual actions of the occupant.

In the aforementioned embodiment, the supply vehicle 30 that performs automated driving acquires a supply of a power source that can be supplied to the vehicle 20 from the information processing device 10 and supplies the power source using the supply unit 34, but the disclosure is not limited thereto. For example, the information processing system 1 may include a terminal device of a supplier that manages an arbitrary supply device for supplying a power source to a vehicle 20 instead of the supply vehicle 30. In this case, the supplier may acquire a supply of a power source that can be supplied to a vehicle 20 from the information processing device 10 using the terminal device and supply the power source to the vehicle 20 using the supply device.

In the aforementioned embodiment, the information processing device 10 acquires the second usage of the power source of the vehicle 20 before the refuge of the occupant in the vehicle 20 has been started, but the disclosure is not limited thereto. For example, the information processing device 10 may acquire the second usage of the power source in the vehicle 20 stored in the storage unit 22 of the vehicle 20 after the refuge of the occupant in the vehicle 20 has been started.

In the aforementioned embodiment, the information processing device 10 acquires the occupant configuration of the vehicle 20 and the fuel efficiency of the vehicle 20 after the refuge of the occupant in the vehicle 20 has been started, but the disclosure is not limited thereto. For example, the information processing device 10 may acquire the occupant configuration of the vehicle 20 and the fuel efficiency of the vehicle 20 before the refuge of the occupant in the vehicle 20 has been started.

In the aforementioned embodiment, the vehicle 20 acquires the occupant configuration based on an image captured by an arbitrary imaging module that can image the inside of the vehicle 20, but the disclosure is not limited thereto. The vehicle 20 or the information processing device 10 may predict the occupant configuration based on at least one of usage of an air conditioner of the vehicle 20, an output from a seat sensor provided in a seat of the vehicle 20, and an opening/closing situation of a door of the vehicle 20.

In the aforementioned embodiment, the information processing device 10 corrects the determined supply based on at least one of the second usage of the power source of the vehicle 20, the occupant configuration in the vehicle 20, and the fuel efficiency of the vehicle 20, but the disclosure is not limited thereto. For example, the information processing device 10 may correct the determined supply based on a residual amount of the power source of the vehicle 20 in addition thereto or instead thereof.

What is claimed is:

1. An information processing device comprising:
a control unit configured to acquire first usage of a power source of a vehicle that supplies energy used in the vehicle in a predetermined period in which an occupant takes refuge by staying in the vehicle and to determine a supply of the power source which is able to be supplied to the vehicle based on the acquired first usage.

2. The information processing device according to claim 1, wherein the control unit is configured to determine that the refuge of the occupant has started based on input information acquired from the occupant by the vehicle.

3. The information processing device according to claim 1, wherein the control unit is configured to determine that the refuge of the occupant has started based on position information of the vehicle, a parking time of the vehicle, and a riding time of the occupant in the vehicle.

4. The information processing device according to claim 1, wherein the control unit is configured to correct the determined supply based on an occupant configuration in the vehicle.

5. The information processing device according to claim 1, wherein the control unit is configured to acquire second usage of the power source in a normal period before the refuge of the occupant has started and to correct the determined supply based on the acquired second usage.

6. The information processing device according to claim 1, wherein the control unit is configured to correct the determined supply based on a fuel efficiency of the vehicle.

7. The information processing device according to claim 1, wherein the power source includes at least one of petroleum fuel, electric power, and hydrogen fuel.

8. An information processing system comprising:
the information processing device according to claim 1; and
a vehicle configured to transmit information of the first usage of the power source of the vehicle that supplies energy used in the vehicle.

9. A program causing an information processing device to perform an operation including:
acquiring first usage of a power source of a vehicle that supplies energy used in the vehicle in a predetermined period in which an occupant takes refuge by staying in the vehicle; and
determining a supply of the power source which is able to be supplied to the vehicle based on the acquired first usage.

10. The program according to claim 9, wherein the operation further includes determining that the refuge of the occupant has started based on input information acquired from the occupant by the vehicle.

11. The program according to claim 9, wherein the operation further includes determining that the refuge of the occupant has started based on position information of the vehicle, a parking time of the vehicle, and a riding time of the occupant in the vehicle.

12. The program according to claim 9, wherein the operation further includes correcting the determined supply based on an occupant configuration in the vehicle.

13. The program according to claim 9, wherein the operation further includes acquiring second usage of the power source in a normal period before the refuge of the occupant has started and correcting the determined supply based on the acquired second usage.

14. The program according to claim 9, wherein the operation further includes correcting the determined supply based on a fuel efficiency of the vehicle.

15. A supply vehicle comprising:
a control unit configured to acquire first usage of a power source of a vehicle that supplies energy used in the vehicle in a predetermined period in which an occupant takes refuge by staying in the vehicle and to determine a supply of the power source which is able to be supplied to the vehicle based on the acquired first usage.

16. The supply vehicle according to claim 15, wherein the control unit is configured to determine that the refuge of the occupant has started based on input information acquired from the occupant by the vehicle.

17. The supply vehicle according to claim 15, wherein the control unit is configured to determine that the refuge of the occupant has started based on position information of the vehicle, a parking time of the vehicle, and a riding time of the occupant in the vehicle.

18. The supply vehicle according to claim 15, wherein the control unit is configured to correct the determined supply based on an occupant configuration in the vehicle.

19. The supply vehicle according to claim 15, wherein the control unit is configured to acquire second usage of the power source in a normal period before the refuge of the occupant has started and to correct the determined supply based on the acquired second usage.

20. The supply vehicle according to claim 15, wherein the control unit is configured to correct the determined supply based on a fuel efficiency of the vehicle.
